(19) United States
(12) Patent Application Publication
(10) Pub. No.: US 2013/0137293 A1
(43) Pub. Date: May 30, 2013

(54) CONNECTOR FOR PLANAR CABLES

(71) Applicants: Kazunori Miura, Makinohara-shi (JP); Kouichi Ohyama, Makinohara-shi (JP); Takatoshi Suzuki, Makinohara-shi (JP)

(72) Inventors: Kazunori Miura, Makinohara-shi (JP); Kouichi Ohyama, Makinohara-shi (JP); Takatoshi Suzuki, Makinohara-shi (JP)

(73) Assignee: YAZAKI CORPORATION, Tokyo (JP)

(21) Appl. No.: 13/814,986

(22) PCT Filed: Aug. 4, 2011
(86) PCT No.: PCT/JP2011/067856

§ 371 Date: Feb. 8, 2013

(30) Foreign Application Priority Data
Aug. 10, 2010 (JP) 2010-179339

(51) Int. Cl. H01R 13/58

(52) U.S. Cl. CPC H01R 13/582
USPC 439/499

(57) ABSTRACT

The present invention provides a connector for planar cables, which can reliably electrically connect a planar cable conductor and a mating terminal. The connector (1) for planar cables comprises: a planar cable (3) provided with a plurality of conductors; a connector housing (5) with an insertion port (31) where the planar cable (3) is inserted disposed on one side; and a fork-shaped mating terminal (7) that is inserted from the thickness direction of the planar cable (3) and electrically connected to a conductor. A slider (11) comprising resin that covers one surface in the conductor thickness direction is disposed on the planar cable (3); a housing (33) that restricts movement in the insertion direction towards the connector housing (5), houses the slider (11), and communicates with the insertion port (31) is disposed in the connector housing (5); and an end section on the other side from the connector housing (5) for the slider (11) protrudes towards the outside of the connector housing (5) from the housing (33), is inserted into the mating terminal (7), and electrically connects the planar cable (3) conductors and the mating terminal (7).

### TECHNICAL FIELD

The present invention relates to a connector for a planar cable.

### BACKGROUND ART

A connector for a planar cable has been known which has a flexible planar cable such as flexible printed circuit (FPC) board and flexible flat cable (FFC), a connector in which an end portion of the planar cable is inserted and accommodated and a fork-shaped mating terminal that is accommodated in the connector, is inserted from a thickness direction of the planar cable and is electrically connected to a conductor of the planar cable (for example, refer to Patent Document 1).

The connector for a planar cable has an ear part at the planar cable and a displaceable latch part at the connector. When the planar cable is inserted into the connector, the latch part is latched to the ear part. Thereby, the connector prevents the planar cable from being separated and also prevents the latch part from being displaced downwards, thereby preventing the latch part from being latch-released from the ear part.

### TECHNICAL DOCUMENTS

### Patent Documents

[Patent Document 1] JP-A-2010-33978

### SUMMARY OF THE PRESENT INVENTION

### Problems to be Solved

However, according to the connector for a planar cable, the mating terminal that is electrically connected to the conductor of the planar cable has the fork shape and the conductor is inserted therein. Hence, it is not possible to secure sufficient contact load between the conductor of the planar cable and the mating terminal. As a result, the electrical connection between the planar cable and the mating terminal may become insufficient.

Accordingly, an object of the present invention is to provide a connector for a planar cable capable of securely electrically connecting a conductor of a planar cable and a mating terminal.

### Means for Solving the Problems

The object of the present invention is realized by following configurations.

(1) A connector for a planar cable includes a planar cable that is provided with a plurality of conductors; a connector housing having an insertion port at one side thereof, into which the planar cable is inserted, and a fork-shaped mating terminal that is inserted from a thickness direction of the planar cable and is electrically connected to the conductors. The planar cable is provided with a slider that is made of a resin and covers one surface thereof in a thickness direction of the conductors. The connector housing is provided with an accommodation part that communicates with the insertion port, accommodates the slider therein and restricts movement of the planar cable in an insertion direction towards the connector housing. An end portion of the slider at the other side of the connector housing protrudes from the accommodation part towards an outside of the connector housing and is inserted into the mating terminal to thus electrically connect the conductors of the planar cable and the mating terminal.

According to the connector for a planar cable having the above configuration (1), the mating terminal inserts therein the slider and the conductors of the planar cable. Therefore, it is possible to apply sufficient contact load between the conductors of the planar cable and the mating terminal by adjusting a thickness of the slider made of a resin.

Hence, according to the connector for a planar cable having the above configuration (1), it is possible to securely electrically connect the conductors of the planar cable and the mating terminal.

Also, since any one surface of the planar cable in a thickness direction of the conductors is covered with the slider, it is possible to prevent the planar cable from being damaged.

Also, the connector housing is provided with the accommodation part that accommodates therein the slider and restricts the movement of the planar cable in the insertion direction towards the connector housing. Thus, it is possible to determine the insertion position of the planar cable into the connector housing, so that it is possible to easily insert the planar cable into the connector housing. In addition, it is possible to prevent the position-deviation of the conductors of the planar cable, so that it is possible to reliably electrically connect the mating terminal and the conductors.

(2) In the connector for a planar cable of the above configuration (1), the planar cable is provided with a first seal member that seals the planar cable and the insertion port of the connector housing therebetween.

According to the connector for a planar cable having the above configuration (2), the planar cable is provided with the first seal member that seals the planar cable and the insertion port of the connector housing therebetween. Thus, it is possible to prevent the water from being introduced from the insertion port of the connector housing into the connector.

(3) In the connector for a planar cable of the above configuration (1) or (2), the mating terminal is accommodated in a terminal accommodation part of a mating connector that is inserted from an opening formed at the other side of the connector housing and is fitted with the connector housing so that it covers an outer periphery of the accommodation part, and the accommodation part of the connector housing is provided on its outer periphery with a second seal member that seals the mating connector and the outer periphery of the accommodation part of the connector housing therebetween.

According to the connector for a planar cable having the above configuration (3), the mating terminal is accommodated in the terminal accommodation part of the mating connector that is fitted with the connector housing. Therefore, it is possible to hold the mating terminal and to thus stabilize the electrical connection between the conductors of the planar cable and the mating terminal.

Also, the outer periphery of the accommodation part of the connector housing is provided with the second seal member that seals the mating connector and the outer periphery of the accommodation part of the connector housing therebetween. Hence, it is possible to prevent the water from being introduced from the opening of the connector housing into the connector.

(4) In the connector for a planar cable having one of the above configurations (1) to (3), an opening end portion of the connector housing having the insertion port formed thereto is mounted with a holder that inserts and holds the planar cable therein and restricts movement of the planar cable in a separating direction from the connector housing.

According to the connector for a planar cable having the above configuration (4), the holder that inserts and holds therein the planar cable and restricts the movement of the planar cable in the separating direction from the connector housing is mounted to the insertion port of the connector housing. Thus, it is possible to stabilize the holding state of the planar cable in the connector housing and to prevent the planar cable from being separated from the connector housing, thereby stabilizing the electrical connection between the conductors of the planar cable and the mating terminal.

(5) In the connector for a planar cable of the above configuration (4), the holder has a U shape in which one of both side surfaces thereof is opened, the planar cable is inserted from the opening of the holder and is then supported to the holder, both side surfaces of the holder are symmetrically provided with a plurality of ribs, respectively, and both side surfaces of the opening end portion of the connector housing are symmetrically provided with engaging recesses with which the ribs are respectively engaged, respectively.

According to the connector for a planar cable having the above configuration (5), the holder has the U shape having one side surface opened. However, the ribs and the engaging recesses are engaged, so that it is possible to prevent the holder from being deformed in an enlarging direction from the opening.

Also, the ribs and the engaging recesses are symmetrically provided, respectively. Hence, it is possible to mount the U-shaped holder having the planar cable inserted therein to any side surface of the opening end portion of the connector housing by engaging the ribs and the engaging recesses, so that it is possible to improve a mount capability of the holder to the connector housing.

### BRIEF DESCRIPTION OF THE DRAWINGS

FIG. 1 is a perspective view of a connector for a planar cable according to a first embodiment of the present invention.

FIG. 2 is a sectional view of the connector for a planar cable according to the first embodiment of the present invention.

FIG. 3 is a perspective view of a cable assembly of the connector for a planar cable according to the first embodiment of the present invention.

FIG. 4 is a sectional view of the cable assembly of the connector for a planar cable according to the first embodiment of the present invention.

FIG. 5 is an exploded perspective view of the cable assembly of the connector for a planar cable according to the first embodiment of the present invention.

FIG. 6 is a perspective view of a connector housing of the connector for a planar cable according to the first embodiment of the present invention.

FIG. 7 is a sectional view of the connector housing of the connector for a planar cable according to the first embodiment of the present invention.

FIG. 8 is a perspective view of a mating terminal of the connector for a planar cable according to the first embodiment of the present invention.

FIG. 9 is a perspective view of a mating connector of the connector for a planar cable according to the first embodiment of the present invention.

FIG. 10 is a front view of the mating connector of the connector for a planar cable according to the first embodiment of the present invention.

FIG. 11 is a sectional view showing a state that the mating terminal and the mating connector of the connector for a planar cable according to the first embodiment of the present invention are mounted.

FIG. 12 is a perspective view of a connector for a planar cable according to a second embodiment of the present invention.

FIG. 13 is a sectional view of the connector for a planar cable according to the second embodiment of the present invention.

FIG. 14 is a perspective view of a holder of the connector for a planar cable according to the second embodiment of the present invention.

FIG. 15 is a front view of the holder of the connector for a planar cable according to the second embodiment of the present invention.

FIG. 16 is a perspective view of a connector housing of the connector for a planar cable according to the second embodiment of the present invention.

FIG. 17 is a perspective view showing a state that the holder of the connector for a planar cable according to the second embodiment of the present invention is being mounted to the connector housing.

FIG. 18(a) is a front view showing a state that the holder of the connector for a planar cable according to the second embodiment of the present invention is being mounted to the connector housing from one side and FIG. 18(b) is a front view showing a state that the holder of the connector for a planar cable according to the second embodiment of the present invention is being mounted to the connector housing from the other side.

FIG. 19 is a perspective view and an enlarged view of main parts showing a state that the holder of the connector for a planar cable according to the second embodiment of the present invention is being mounted to the connector housing

### EMBODIMENT FOR CARRYING OUT THE PRESENT INVENTION

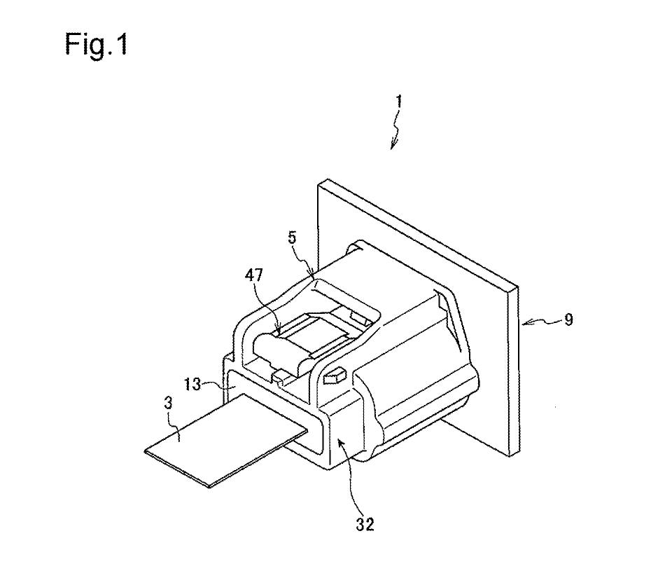

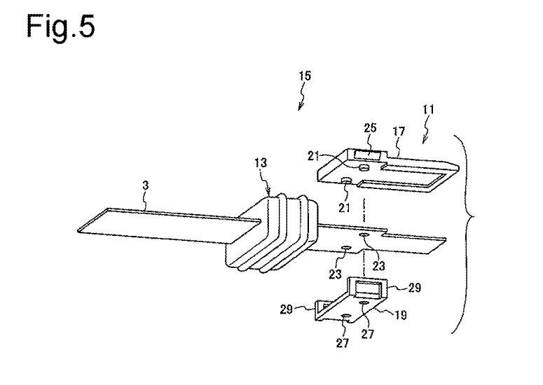

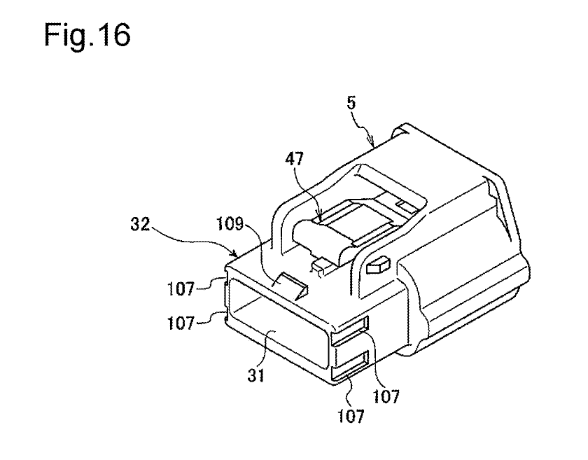

A connector for a planar cable according to embodiments of the present invention will be described with reference to FIGS. 1 to 19.

### First Embodiment

A first embodiment of the present invention is described with reference to FIGS. 1 to 11.

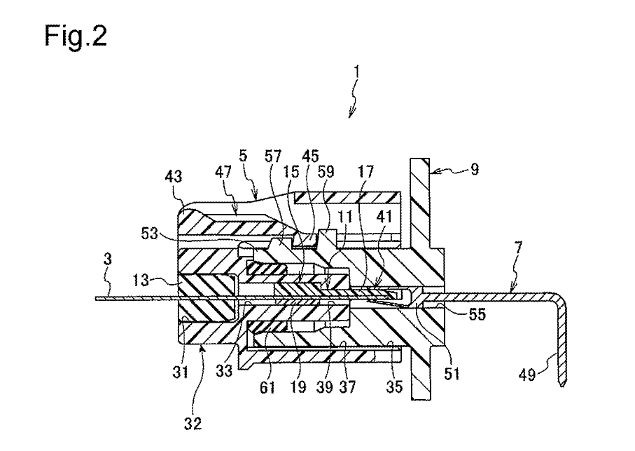

As shown in FIGS. 1 and 2, a connector 1 for a planar cable according to the first embodiment has a planar cable 3, a connector housing 5, mating terminals 7 and a mating connector 9.

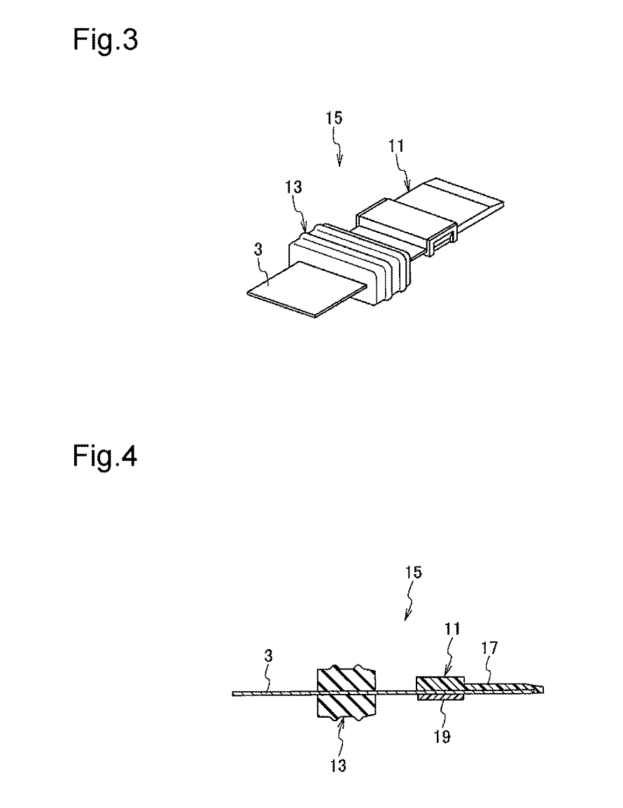

As shown in FIGS. 3 to 5, the planar cable 3 is a flexible planar cable such as FPC and FFC and has a plurality of conductors (not shown). The planar cable 3 is mounted with a slider 11 and a seal material 13 serving as a first seal member, so that a cable assembly 15 is configured.

The slider 11 is made of a resin material and has a slider body 17 and a slider cover 19. The slider body 17 is mounted on an upper surface of the planar cable 3 so that it covers the conductors of the planar cable 3. Also, a surface (lower surface) of the slider body 17 facing the planar cable 3 is provided with a plurality of (two, in this embodiment) protruding bosses 21.

The bosses 21 are inserted into boss holes 23 provided to the planar cable 3 and fix a position of the slider body 17 relative to the planar cable 3. Also, both side surfaces of the slider body 17 are provided with protruding beaks 25, thereby fixing the slider cover 19.

The slider cover 19 is mounted on a lower surface of the planar cable 3 so that a part of the conductors of the planar cable 3 covered by the slider body 17 is exposed to an outside. Also, the slider cover 19 is provided with boss holes 27 into which the bosses 21 of the slider body 17, which are inserted into the boss holes 23 of the planar cable 3, are inserted. The bosses 21 are engaged with the boss holes 23, 27, so that the slider 11 is positionally-fixed relative to the planar cable 3. Also, both side surfaces of the slider cove 19 are provided with locks 29 that are engaged with the beaks 25 of the slider body 17. The locks 29 are engaged with the beaks 25, so that the slider body 17 and the slider cover 19 are fixed.

The seal material 13 is made of an elastic material such as rubber, and the planar cable 3 is inserted into a central portion of the seal material with being closely contacted. In the meantime, the seal material 13 and the planar cable 3 may be separately formed and mounted or the seal material 13 may be integrated with the planar cable 3. As shown in FIG. 2, an outer periphery of the seal material 13 is elastically closely contacted to an inner periphery of an insertion port 31 of the connector housing 5, thereby sealing the connector housing 5 and the planar cable 3 therebetween.

The cable assembly 15 that is configured as the slider 11 and the seal material 13 are mounted to the planar cable 3 is inserted from the insertion port 31 of the connector housing 5 and then mounted to the connector housing 5.

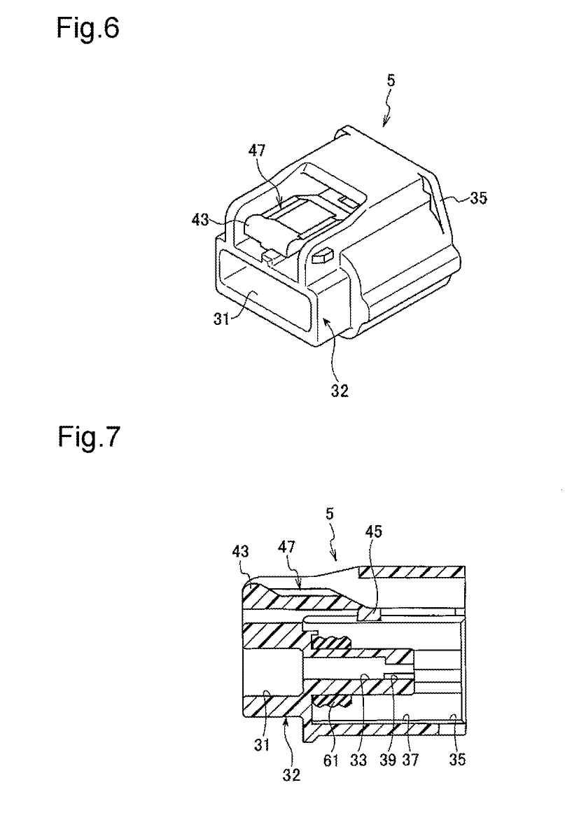

As shown in FIGS. 6 and 7, the connector housing 5 is made of a resin material and has the insertion port 3, an accommodation part 33, an opening 35 and a mating connector accommodation part 37. The insertion port 31 is formed at an opening end portion 32 that opens toward one side of the connector housing 5. From the insertion port 31, the cable assembly 15 is inserted and the cable assembly 15 is thus mounted to the connector housing 5. The seal material 13 of the cable assembly 15 is accommodated in the insertion port 31, so that the connector housing 5 and the planar cable 3 are sealed therebetween.

The accommodation part 33 is provided at a more inward side of the connector housing 5 than the insertion port 31 and communicates with the insertion port 31, thereby forming a cylindrical shape. Also, a bottom of the accommodation part 33 is formed with a through-hole 39. As shown in FIG. 2, the slider 11 of the cable assembly 15 is accommodated in the accommodation part 33 and a part of the slider 11 is inserted into the through-hole 39 and protrudes into the mating connector accommodation part 37. The protruding part of the slider 11 becomes a connection part 41 that is fitted into the mating terminals 7. The slider 11 is accommodated into the accommodation part 33 in this way, so that a base end side of the connection part 41 of the slider 11 is brought into contact with the bottom of the accommodation part 33. Thereby, it is possible to restrict movement of the cable assembly 15 in the insertion direction towards the connector housing 5.

The opening 35 opens towards the other side of the connector housing 5. The mating connector 9 is inserted from the opening 35, so that the mating connector 9 is mounted to the connector housing 5. The opening 35 communicates with the mating connector accommodation part 37 that accommodates therein the mating connector 9.

The mating connector accommodation part 37 is provided on the outer periphery of the accommodation part 33 in the connector housing 5. The mating connector 9 that is inserted from the opening 35 is accommodated in the mating connector accommodation part 37 so that it covers the outer periphery of the accommodation part 33. In the meantime, a lock portion 45 of a lock arm 47 that has an operation part 43 and the lock portion 45 and is swingably provided is positioned on the mating connector accommodation part 37, so that the mating connector 9 is thus fixed relative to the connector housing 5.

The connector housing 5 configured as described above is mounted on a substrate (not shown) such as circuit board and is applied so as to electrically connect the planar cable 3 connected to an electronic part and the like and the mating terminals 7 connected to the substrate.

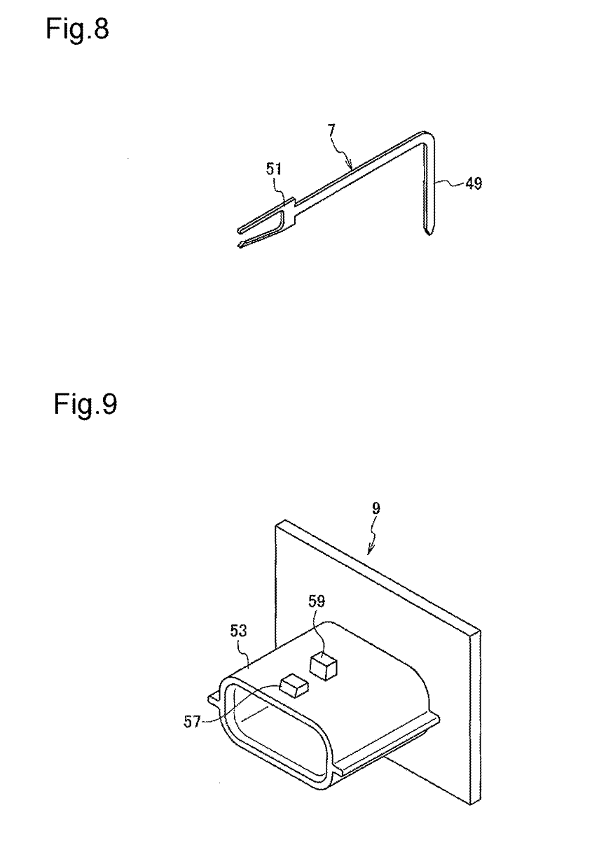

As shown in FIG. 8, the mating terminal 7 is made of a conductive metal material, is formed to have an L shape and has an electrical connection part 49 that is provided at one end thereof and is connected to the substrate and a holding part 51 that is provided at the other end thereof. The holding part 51 has a fork shape that is opened at a leading end thereof so that it can be elastically deformed. As shown in FIG. 2, the connection part 41 of the cable assembly 15 is fitted into the holding part 51, so that the conductors of the planar cable 3 and the mating terminals 7 are electrically connected.

Here, load of the contact between the conductors of the planar cable 3 and the holding part 51, which is made as the holding part 51 is fitted, is adjusted by changing a thickness of the slider body 17 of the slider 11 at the connection part 41. Thereby, even when the planar cable 3 is thin and a width of a displacement amount of the holding part 51 is small, it is possible to enable the holding part 51 to have the width of the displacement amount by changing the thickness of the slider body 17, thereby adjusting the contact load.

The mating terminals 7 are accommodated in the mating connector 9 and fit the mating connector 9 and the connector housing 5, so that they are electrically connected to the planar cable 3.

As shown in FIGS. 9 to 11, the mating connector 9 is made of a resin material and has a fitting part 53 and a terminal accommodation part 55. The fitting part 53 has a cylindrical shape and is accommodated in the mating connector accommodation part 37 of the connector housing 5 so that it covers the outer periphery of the accommodation part 33 of the connector housing 5. Also, a peripheral upper surface of the fitting part 53 is provided with a pair of protruding beak portions 57, 59 that is engaged with the lock portion 45 of the lock arm 47 of the connector housing 5. One beak portion 57 of the pair of beak portions 57, 59, which is positioned at the front in the insertion direction of the mating connector 9, has a protruding height that is lower than the other beak portion 59 and a front surface thereof in the insertion direction is inclined. Hence, when the mating connector 9 is fitted with the connector housing 5, the lock portion 45 of the lock arm 47 surmounts the inclined surface of the one beak portion 57 and then contacts the other beak portion 59, so that it is engaged between the pair of beak portions 57, 59. The pair of beak portions 57, 59 and the lock portion 45 of the lock arm 47 are engaged, so that the fitting position of the mating connector 9 to the connector housing 5 is kept. In the meantime, the engaging can be released by pushing down the operation part 43 of the lock arm 47. Thereby, the fitting between the connector housing 5 and the mating connector 9 can be released.

Here, as shown in FIG. 7, an outer periphery of the accommodation part 33 of the connector housing 5 is provided with a rubber packing 61 serving as a second seal member that seals the mating connector 9 and the outer periphery of the accommodation part 33 of the connector housing 5 therebetween. As shown in FIG. 2, the rubber packing 61 is closely contacted at an inner periphery thereof to the outer periphery of the accommodation part 33 and is elastically closely contacted at an outer periphery thereof to an inner periphery of the fitting part 53 of the mating connector 9, thereby sealing the connector housing 5 and the mating connector 9 therebetween. The fitting part 53 communicates with the terminal accommodation part 55.

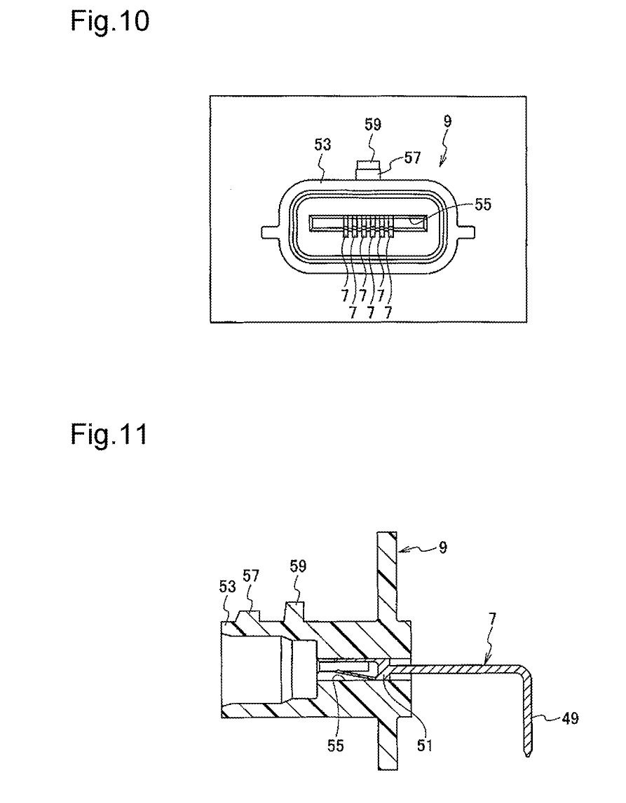

As shown in FIG. 10, the terminal accommodation part 55 is a through-hole extending in a width direction of the mating connector 9 and accommodates therein the mating terminals 7. In the meantime, the number of the mating terminals 7 to be accommodated is appropriately selected depending on a circuit that is set. Also, as shown in FIG. 2, the connection part 41 of the cable assembly 15 is inserted into the terminal accommodation part 55, so that the planar cable 3 and the mating terminals 7 are electrically connected. Like this, the planar cable 3 and the mating terminals 7 are electrically connected in the terminal accommodation part 55, so that they are prevented from being position-deviated.

According to the connector 1 for a planar cable, the slider 11 and the conductors of the planar cable 3 are inserted into the mating terminals 7. Therefore, it is possible to apply the sufficient contact load between the conductors of the planar cable 3 and the mating terminals 7 by adjusting the thickness of the slider 11 made of the resin.

Hence, according to the connector 1 for a planar cable, it is possible to securely electrically connect the conductors of the planar cable 3 and the mating terminals 7.

Also, since the one surface of the planar cable 3 in the thickness direction of the conductors is covered by the slider 11, it is possible to prevent the planar cable 3 from being damaged.

Also, the connector housing 5 is provided with the accommodation part 33 that accommodates therein the slider 11 and restricts the movement of the planar cable 3 in the insertion direction towards the connector housing 5. Thus, it is possible to determine the insertion position of the planar cable 3 into the connector housing 5, so that it is possible to easily insert the planar cable 4 into the connector housing 5. In addition, it is possible to prevent the position-deviation of the conductors of the planar cable 3, so that it is possible to reliably electrically connect the mating terminals 7 and the conductors.

Also, the planar cable 3 is provided with the seal material 13 that seals the planar cable 3 and the inner periphery of the insertion port 31 of the connector housing 5 therebetween. Thus, it is possible to prevent the water from being introduced from the insertion port 31 of the connector housing 5 into the connector housing 5.

Also, the mating terminals 7 are accommodated in the terminal accommodation part 55 of the mating connector 9 that is fitted with the connector housing 5. Therefore, it is possible to hold the mating terminals 7 and to thus stabilize the electrical connection between the conductors of the planar cable 3 and the mating terminals 7.

Also, the outer periphery of the accommodation part 33 of the connector housing 5 is provided with the rubber packing 61 that seals the mating connector 9 and the outer periphery of the accommodation part 33 of the connector housing 5 therebetween. Hence, it is possible to prevent the water from being introduced from the opening 35 of the connector housing 5 into the connector housing 5.

### Second Embodiment

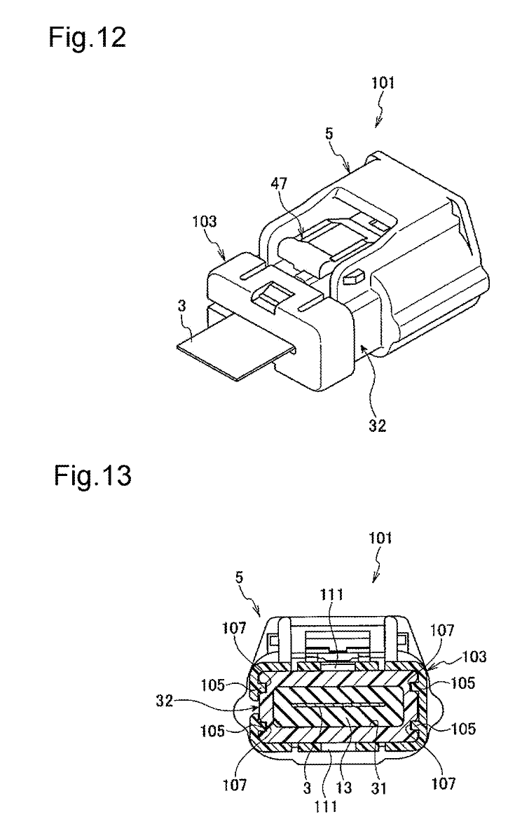

A second embodiment of the present invention is described with reference to FIGS. 12 to 19.

As shown in FIGS. 12 and 13, a connector 101 for a planar cable according to the second embodiment has a holder 103. In the meantime, the same configurations as those of the first embodiments are indicated with the same reference numerals and the descriptions thereof are omitted. The configurations and functions of the second embodiment, which are the same as those of the first embodiment, are referred to the first embodiment and the descriptions thereof are omitted. However, the effects to be realized are the same.

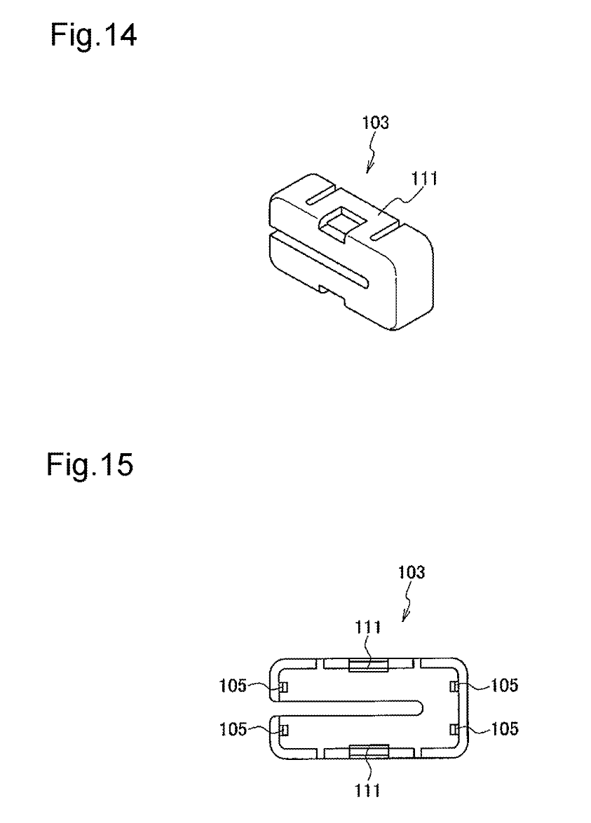

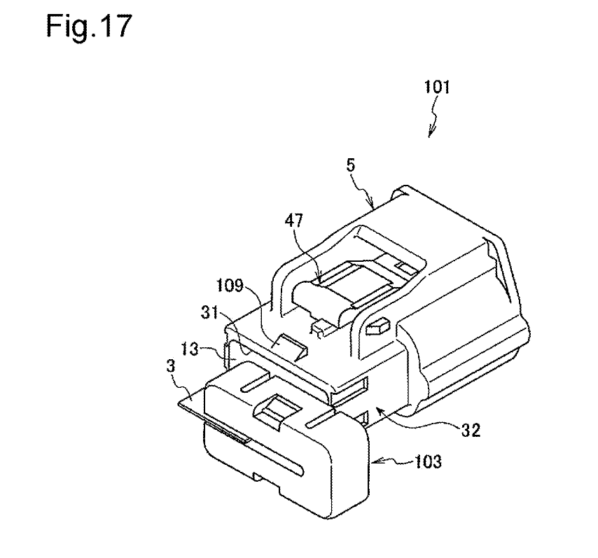

As shown in FIGS. 14 and 15, the holder 103 is made of a resin material and has a U shape in which one side surface is opened. As shown in FIG. 17, the holder 103 inserts therein the planar cable 3 from an opening thereof and is thus mounted to the connector housing 5 so that it covers the outer periphery of the opening end portion 32 of the connector housing 5. The holder 103 is mounted to the connector housing 5, so that the movement of the planar cable 5 in a separating direction from the connector housing 5 is restricted. Thus, it is possible to hold the planar cable 3 in the connector housing 5. A plurality of (two, respectively, in this embodiment) ribs 105 is provided on both inner side surfaces of the holder 103.

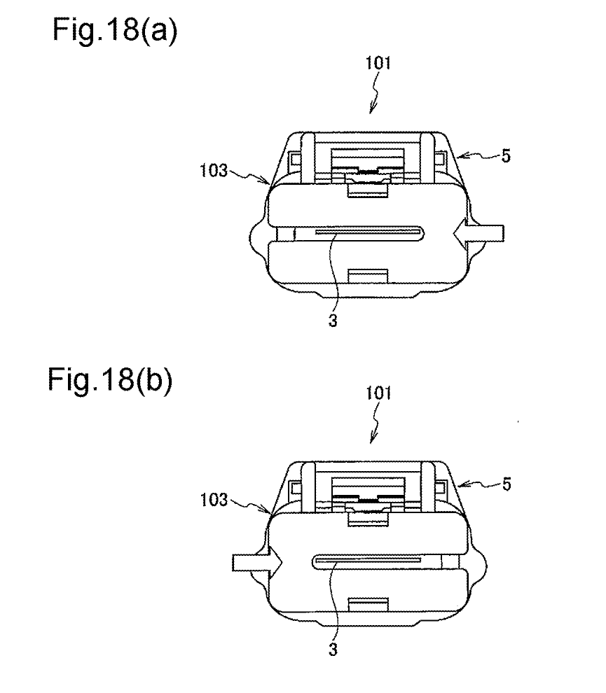

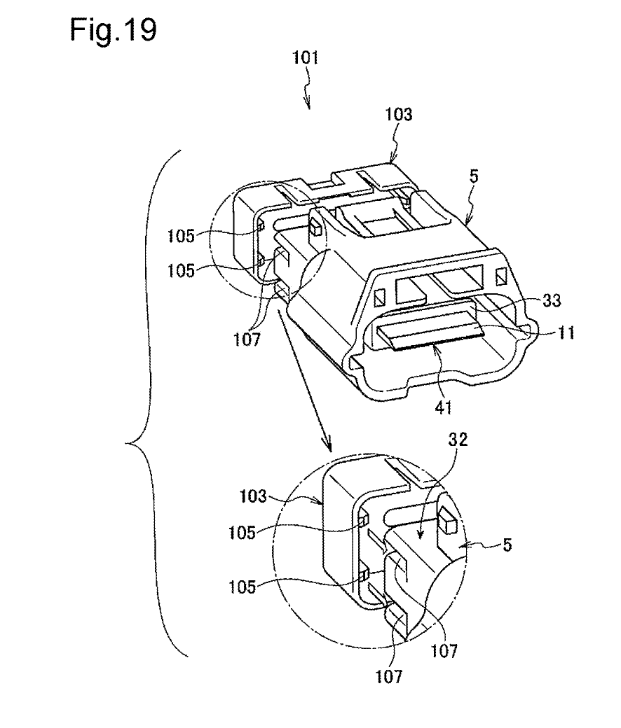

The ribs 105 protrude from both side surfaces towards the inside of the holder 103. As shown in FIG. 19, the ribs 105 are engaged with a plurality of (two, respectively, in this embodiment) engaging recesses 107 that is provided on both outer side surfaces of the opening end portion 32 of the connector housing 5. Also, as shown in FIGS. 13, 15 and 16, the ribs 105 and the engaging recesses 107 are symmetrically provided on both side surfaces of the holder 103 and both side surfaces of the opening end portion 32 of the connector housing 5, respectively. Therefore, as shown in FIGS. 18(a) and 18(b), even when the holder 103 is inserted from any side in the width direction of the planar cable 3, the ribs 105 and the engaging recesses 107 can be engaged, so that it is possible to improve the mount operability because the positioning operation and the like are omitted. Also, the holder 103 is provided at upper and lower surfaces thereof with lock portions 111 that are engaged with beak portions 109 (only one of them is shown) protruding from upper and lower surfaces of the opening end portion 32 of the connector housing 5, respectively. When the holder 103 is moved in a mount direction, the lock portions 111 surmount inclined surfaces of leading ends of the beak portions 109 and are engaged to rear end surfaces of the beak portions 109.

Here, since the holder 103 is formed to have the U shape, when the force is applied in an enlarging direction from the opening, for example upon the engagement of the lock portions 111 and the beak portions 109, the stress is concentrated on an opposite side surface to the opening, so that the holder may be deformed or damaged. However, the ribs 105 of the holder 103 are engaged with the engaging recesses 107 and the force is thus prevented from being applied to the holder 103 in the enlarging direction from the opening, so that it is possible to prevent the holder 103 from being deformed or damaged. In addition, since the holder 103 is not enlarged from the opening, it is possible to hold the engagement between the lock portions 111 and the beak portions 109.

According to the connector 101 for a planar cable, the holder 103 that inserts and holds the planar cable 3 and restricts the movement of the planar cable 3 in the separating direction from the connector housing 5 is mounted to the insertion port 31 of the connector housing 5. Thus, it is possible to stabilize the holding state of the planar cable 3 in the connector housing 5 and to prevent the planar cable 3 from being separated from the connector housing 5, thereby stabilizing the electrical connection between the conductors of the planar cable 3 and the mating terminals 7 (for example, refer to FIG. 2).

Also, the holder 103 has the U shape having one side surface opened. However, the ribs 105 and the engaging recesses 107 are engaged, so that it is possible to prevent the holder 103 from being deformed in the enlarging direction from the opening.

Also, the ribs 105 and the engaging recesses 107 are symmetrically provided, respectively. Hence, it is possible to mount the U-shaped holder 103 having the planar cable 3 inserted therein to any side surface of the opening end portion 32 of the connector housing 5 by engaging the ribs 105 and the engaging recesses 107, so that it is possible to improve the mount capability of the holder 103 to the connector housing 5.

In the meantime, according to the connector for a planar cable of this embodiment, the mating terminals are accommodated in the mating connector. However, a configuration is also possible in which the opening-side of the connector housing is provided with an accommodation part accommodating the mating terminals therein and the mating terminals are accommodated in the connector housing.

Also, the ribs and the engaging recesses that are respectively provided to the holder and the opening end portion of the connector housing are symmetrically provided on both side surfaces thereof, respectively. However, the present invention is not limited thereto. For example, the ribs and the engaging recesses may be symmetrically provided on the upper and lower surfaces of the holder and the opening end portion of the connector housing.

Although the connector for a planar cable has been specifically described with reference to the specific embodiments, the present invention is not limited to the above embodiments. The present invention can be variously modified without departing from the gist of the present invention.

This application is based on Japanese Patent Application No. 2010-179399 filed on Aug. 10, 2010, the disclosures of which are incorporated herein by reference.

### INDUSTRIAL APPLICABILITY

According to the connector for a planar cable, it is possible to provide a connector for a planar cable capable of securely electrically connecting a conductor of a planar cable and a mating terminal.

### DESCRIPTION OF THE REFERENCE NUMERALS

1, 101: connectod for a planar cable

3: planar cable

5: connector housing

7: mating terminal

9: mating connector

11: slider

13: seal material (first seal member)

31: insertion port

32: opening end portion

33: accommodation part

35: opening

55: terminal accommodation part

61: rubber packing (second seal member)

103: holder

105: rib

107: engaging recess

1. A connector for a planar cable comprising:
a planar cable provided with a plurality of conductors;
a connector housing having an insertion port at one side thereof, into which the planar cable is inserted, and
a fork-shaped mating terminal inserted from a thickness direction of the planar cable and is electrically connected to the conductors,
wherein the planar cable is provided with a slider that is made of a resin and covers one surface thereof in a thickness direction of the conductors,
wherein the connector housing is provided with an accommodation part that communicates with the insertion port, accommodates the slider therein and restricts movement of the planar cable in an insertion direction towards the connector housing, and
wherein an end portion of the slider at the other side of the connector housing protrudes from the accommodation part towards an outside of the connector housing and is inserted into the mating terminal to thus electrically connect the conductors of the planar cable and the mating terminal.

2. The connector for a planar cable according to claim 1, wherein the planar cable is provided with a first seal member that seals the planar cable and the insertion port of the connector housing therebetween.

3. The connector for a planar cable according to claim 1, wherein the mating terminal is accommodated in a terminal accommodation part of a mating connector that is inserted from an opening formed at the other side of the connector housing and is fitted with the connector housing so that it covers an outer periphery of the accommodation part, and
wherein the accommodation part of the connector housing is provided on its outer periphery with a second seal member that seals the mating connector and the outer periphery of the accommodation part of the connector housing therebetween.

4. The connector for a planar cable according to claim 1 or 2claim 1, wherein an opening end portion of the connector housing having the insertion port formed thereto is mounted with a holder that inserts and holds the planar cable therein and restricts movement of the planar cable in a separating direction from the connector housing.

5. The connector for a planar cable according to claim 4, wherein the holder has a U shape in which one of both side surfaces thereof is opened, the planar cable is inserted from the opening of the holder and is then supported to the holder, both side surfaces of the holder are symmetrically provided with a plurality of ribs, respectively, and both side surfaces of the opening end portion of the connector housing are symmetrically provided with engaging recesses with which the ribs are respectively engaged, respectively.

6. The connector for a planar cable according to claim 3, wherein an opening end portion of the connector housing having the insertion port formed thereto is mounted with a holder that inserts and holds the planar cable therein and restricts movement of the planar cable in a separating direction from the connector housing.

7. The connector for a planar cable according to claim 6, wherein the holder has a U shape in which one of both side surfaces thereof is opened, the planar cable is inserted from the opening of the holder and is then supported to the holder, both side surfaces of the holder are symmetrically provided with a plurality of ribs, respectively, and both side surfaces of the opening end portion of the connector housing are symmetrically provided with engaging recesses with which the ribs are respectively engaged, respectively.
